(19) United States
(12) Patent Application Publication
(10) Pub. No.: US 2008/0073605 A1
(43) Pub. Date: Mar. 27, 2008

(54) Fluid-controlled valve

(75) Inventors: Satoshi Ishigaki, Takahama-city (JP); Tadashi Komiyama, Chiryu-city (JP); Takahiro Kouzo, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/892,498

(22) Filed: Aug. 23, 2007

(30) Foreign Application Priority Data
Sep. 25, 2006 (JP) 2006-258201

(51) Int. Cl. F16K 31/12

(52) U.S. Cl. 251/12

(57) ABSTRACT

A fluid-controlled valve includes a housing, a valve, and a sealing member. The housing has an annular valve seat, which has a fluid passing hole therein. The valve sits on or is separated from the valve seat to close or open the fluid passing hole respectively. The sealing member is attached on the valve. The sealing member has a sealing lip, which is closely attached to the valve seat while the fluid passing hole is closed by the valve, to seal a gap between the valve seat and the valve. The sealing member has a load receiving portion, which contacts the valve seat while the fluid passing hole is closed by the valve, in addition to the sealing lip.

### CROSS REFERENCE TO RELATED APPLICATION

This application is based on and incorporates herein by reference Japanese Patent Application No. 2006-258201 filed on Sep. 25, 2006.

### BACKGROUND OF THE INVENTION

1. Field of the Invention

The present invention relates to a fluid-controlled valve.

2. Description of Related Art

Conventionally, a secondary air supply system, in which warming-up of a three-way catalyst is promoted by drawing secondary air generated in a secondary air flow passage pipe when an engine is started into a three-way catalytic converter, is known. The three-way catalytic converter purifies exhaust gas, which flows out of a combustion chamber of the engine. The secondary air supply system has a secondary air control valve as a result of integrating an electromagnetic valve with a check-valve (e.g., see JP2002-340216A, pp. 1-7, FIG. 1).

In the secondary air control valve integrated into the secondary air supply system, there is a possibility of a backflow of high-temperature fluid (e.g., high-temperature exhaust gas equal to or higher than 500° C.) from a connected portion between an engine exhaust pipe and the secondary air flow passage pipe into the inside of the secondary air control valve due to exhaust pulsation caused by opening/closing of an exhaust valve of the engine. In this case, when sealing properties (between a valve and a valve seat) of the inside of the electromagnetic valve are low, high-temperature exhaust gas repeatedly flows over a long duration through a gap between the valve and the valve seat, and a flow passage hole (valve hole) formed in the valve seat into the inside of the secondary air supply system, which is located on an electrical air pump-side of the valve seat. Accordingly, the inside of the secondary air supply system has abnormally high temperatures, thereby causing a system failure.

As shown in FIGS. 8A to 9B, a seal rubber 104 is attached on the periphery of a valve 101 of the electromagnetic valve in order to improve sealing properties between the valve 101 of the electromagnetic valve and a valve seat 103 when the valve 101 of the electromagnetic valve sits on the valve seat 103 (when the valve 101 is closed), in which a flow passage hole 102 is formed. A sealing lip 105, with which to airtightly seal a gap between the valve 101 of the electromagnetic valve and the valve seat 103 when the valve 101 is closed, is formed integrally with the seal rubber 104.

As shown in FIGS. 8A, 8B, 9A, in a valve free state (when the valve 101 is fully open) before the valve 101 of the electromagnetic valve sits on the valve seat 103, the sealing lip 105 is in a natural state, that is, the sealing lip 105 has a circular truncated coned and cylindrical shape, extending generally straight from a valve covering portion 106 of the seal rubber 104 toward a valve seat 103-side and being inclined relative to an axial direction (through-thickness direction) of the valve 101 of the electromagnetic valve.

In the seal rubber 104 having the conventional sealing lip structure, however, the sealing lip 105 serves as a sealing function between the valve 101 of the electromagnetic valve and the valve seat 103 when the valve 101 sits on the valve seat 103 (when the valve 101 is closed), and as a load receiving portion, to which a valve closing load is applied. The valve 101 of the electromagnetic valve is pressed against the valve seat 103 with this valve closing load when the valve 101 is closed.

That is, as shown in FIG. 9B, all the valve closing load by a spring and the like while the valve 101 is closed is applied to the sealing lip 105 of the seal rubber 104. Meanwhile, much strength of the sealing lip 105 is not being allowed for an excessive stress, which is applied to a base portion (root portion) of the sealing lip 105.

Particularly when exhaust pressure is applied to the valve 101 of the electromagnetic valve due to the backflow of high-temperature exhaust gas, and then the valve 101 of the electromagnetic valve is pressed against the valve seat 103, the stress applied to the root portion of the sealing lip 105 becomes even greater. As a result, defects such as a crack are easily caused at the root portion of the sealing lip 105, thereby causing concern that a lifetime (endurance) of the sealing lip 105 may be shortened, or that the sealing function when the valve 101 is closed may be decreased.

### SUMMARY OF THE INVENTION

The present invention addresses the above disadvantages. Thus, it is an objective of the present invention to provide a fluid-controlled valve, which has a load receiving portion in addition to a sealing lip. By providing the load receiving portion to a sealing member having the sealing lip, an excessive stress applied to the sealing lip while the valve is closed is reduced. A valve closing load is applied to the load receiving portion in contact with a valve seat of a housing while the valve is closed.

To achieve the objective of the present invention, there is provided a fluid-controlled valve including a housing, a valve, and a sealing member. The housing has an annular valve seat, which has a fluid passing hole therein. The valve sits on or is separated from the valve seat to close or open the fluid passing hole respectively. The sealing member is attached on the valve. The sealing member has a sealing lip, which is closely attached to the valve seat while the fluid passing hole is closed by the valve, to seal a gap between the valve seat and the valve. The sealing member has a load receiving portion, which contacts the valve seat while the fluid passing hole is closed by the valve, in addition to the sealing lip.

### BRIEF DESCRIPTION OF THE DRAWINGS

The invention, together with additional objectives, features and advantages thereof, will be best understood from the following description, the appended claims and the accompanying drawings in which:

FIG. 1A is a schematic view showing a sealing lip in its natural state when a valve is free, according to a first embodiment of the present invention;

FIG. 1B is a schematic view showing the sealing lip, which is elastically deformed when the valve is fully closed, according to the first embodiment;

FIG. 2 is a schematic view showing a secondary air supply system according to the first embodiment;

FIG. 3 is a cross-sectional view showing a secondary air control valve according to the first embodiment;

FIG. 4A is a cross-sectional view showing a seal rubber, which is attached on a poppet valve according to the first embodiment;

FIG. 4B is another cross-sectional view showing the seal rubber, which is attached on the poppet valve according to the first embodiment;

FIG. 5A is a first schematic view showing the sealing lip, which is elastically deformed when the valve is fully closed, according to a second embodiment of the present invention;

FIG. 5B is a second schematic view showing the sealing lip, which is elastically deformed when the valve is fully closed, according to the second embodiment;

FIG. 5C is a third schematic view showing the sealing lip, which is elastically deformed when the valve is fully closed, according to the second embodiment;

FIG. 6A is a first plan view showing a load receiving portion of the seal rubber according to a third embodiment of the present invention;

FIG. 6B is a second plan view showing the load receiving portion of the seal rubber according to the third embodiment;

FIG. 6C is a third plan view showing the load receiving portion of the seal rubber according to the third embodiment;

FIG. 7A is a plan view showing the load receiving portion of the seal rubber according to a fourth embodiment of the present invention;

FIG. 7B is another plan view showing the load receiving portion of the seal rubber according to the fourth embodiment;

FIG. 8A is a cross-sectional view showing a previously proposed seal rubber, which is attached on a poppet valve;

FIG. 8B is another cross-sectional view showing the previously proposed seal rubber, which is attached on the poppet valve;

FIG. 9A is a cross-sectional view showing the previously proposed seal rubber, which is attached on the poppet valve; and

FIG. 9B is another cross-sectional view showing the previously proposed seal rubber, which is attached on the poppet valve.

### DETAILED DESCRIPTION OF THE INVENTION

Embodiments of the present invention realize a purpose of reducing an excessive stress applied to a sealing lip while a valve is closed by providing a load receiving portion in addition to the sealing lip to a sealing member having the sealing lip. A valve closing load is applied to the load receiving portion in contact with a valve seat of a housing while the valve is closed.

### First Embodiment

A secondary air control valve 1 according to a first embodiment is incorporated into a secondary air supply system (secondary air supply unit). In the secondary air supply system, secondary air, which is generated in secondary air flow passage pipes (fluid flow passage pipes) 11, 12 when an internal combustion engine (engine) 10 such as a gasoline engine is started (engine starting time), is drawn into a three-way catalytic converter 13 as an exhaust emission control system to promote warming-up of a three-way catalyst. The secondary air supply system is installed in an engine room of a vehicle such as an automobile, for example. An electrical air pump 14 is airtightly connected to the secondary air control valve 1 via the secondary air flow passage pipe 11, and the secondary air control valve 1 is airtightly connected to an engine exhaust pipe 16 via the secondary airflow passage pipe 12.

The three-way catalytic converter 13 of the first embodiment is the exhaust emission control system of an internal combustion engine that makes harmless three elements together, namely carbon monoxide (CO), hydrocarbon (HC), and nitrogen oxides (NOₓ), which are harmful components in exhaust gas discharged from a combustion chamber of each cylinder of the engine 10, through a chemical reaction, and particularly that makes hydrocarbon (HC) harmless water (H₂O) through an oxidative effect.

The engine 10 obtains output power from heat energy generated by combusting mixed gas of intake air and fuel in the combustion chamber. The engine 10 has an engine inlet pipe 15, through which intake air is supplied to the combustion chamber of each cylinder, and an engine exhaust pipe 16, through which exhaust gas that flows out of the combustion chamber of each cylinder is discharged into the outside via the three-way catalytic converter 13. The engine 10 has a cylinder block, which slidably supports a piston 17 in a cylinder bore, and a cylinder head having an intake port and an exhaust port. The intake port and the exhaust port of the engine 10 are opened or closed by an inlet valve 18 and an exhaust valve 19, respectively. A spark plug 20 is attached on the cylinder head of the engine 10 such that its end portion is exposed to the combustion chamber. An electromagnetic fuel injection valve (injector) 21, which injects fuel, is attached on a wall surface of the intake port or on a back wall surface of the inlet valve 18.

An air intake passage, which is communicated with the combustion chamber of the engine 10 via the intake port, is formed in the engine inlet pipe 15. Intake air that is drawn into the combustion chamber of the engine 10 flows through the air intake passage. An air cleaner 22 and a throttle valve 24 are received in the engine inlet pipe 15. The air cleaner 22 filters intake air, and the throttle valve 24 opens or closes according to a depression amount (accelerator opening degree) of an accelerator pedal 23.

An exhaust passage, which is communicated with the combustion chamber of the engine 10 via the exhaust port, is formed in the engine exhaust pipe 16. Exhaust gas flowing out of the combustion chamber of the engine 10 into the three-way catalytic converter 13 flows through the exhaust passage. An air/fuel ratio sensor 25, a catalyst temperature sensor 26, an exhaust temperature sensor (not shown) and the like are disposed in the engine exhaust pipe 16. The air/fuel ratio sensor 25 detects an air/fuel ratio of exhaust gas (concentration of oxygen in exhaust gas). The catalyst temperature sensor 26 detects temperature of the three-way catalyst. The exhaust temperature sensor detects exhaust gas temperature.

As described above, the secondary air supply system of the first embodiment includes the secondary air control valve 1, the secondary air flow passage pipes 11, 12, the electrical air pump 14, and the like.

A secondary air passage (fluid passage), which is communicated with the exhaust passage in the engine exhaust pipe 16, is formed in the secondary air flow passage pipes 11, 12. Secondary air flows through the secondary air passage. A pressure sensor 27, which detects pressure of secondary air, and the like are disposed in the secondary air flow passage pipes 11, 12.

The electrical air pump 14 is airtightly connected to an upstream end of the secondary air flow passage pipe 11 in the secondary air supply system. The electrical air pump 14 has an electric motor (not shown), a pump impeller (not shown), and an air filter (not shown). The electric motor generates driving force upon electrical power supply. The pump impeller is driven to rotate by the electric motor. The air filter prevents a foreign object from entering through the pump impeller. Also, the electrical air pump 14 has a motor housing 31, a pump housing 32, and a filter case 34. The motor housing 31 receives and holds the electric motor therein. The pump housing 32 rotatably receives the pump impeller therein. The filter case 34 is airtightly connected to the pump housing 32 via an air duct 33.

The secondary air control valve 1 of the first embodiment airtightly is connected between the secondary air flow passage pipes 11, 12 in the secondary air supply system. The secondary air control valve 1 is an electromagnetic fluid-controlled valve (combi-valve module), which integrates an air switching valve (ASV) and a check-valve. The ASV functions as an electromagnetic passage opening-closing valve (electromagnetic valve), which opens or closes a secondary air passage (fluid passage) 35 that is formed in a housing 2. The check-valve prevents fluid such as exhaust gas from flowing from a merging area between the secondary air flow passage pipe 12 and the engine exhaust pipe 16 back into the inside of the system on an electrical air pump 14-side or an ASV side.

The check-valve has a housing 41, a metal plate 42, a film-like reed valve 44, and a reed stopper 45. The housing 41 is joined to a downstream side of the housing 2 of the ASV in a secondary air flowing direction. The metal plate 42 is held by the housing 41. The reed valve 44 opens or closes a plurality of air passing outlets (valve holes of the check-valve, flow passage holes) 43, which are formed inside the metal plate 42. The reed stopper 45 restricts a degree of opening (maximum opening degree) of the reed valve 44. The housing 41 is airtightly connected to an upstream end of the secondary air flow passage pipe 12. In the first embodiment, when the reed valve 44 is opened, secondary air, which flows through the plurality of air passing outlets 43 into the inside (fluid delivery passage 46) of the housing 41, flows out of an outlet portion (outlet port) 47 of the housing 41. The reed valve 44 is a valve body (of the check-valve), which is opened by pressure of secondary air discharged from the electrical air pump 14.

The ASV has the housing 2, a poppet valve 4, a coil spring 7, and a seal rubber 9. The secondary air passage 35 is formed in the housing 2. The poppet valve 4 makes reciprocative linear motion in a direction of a central axis of an annular valve seat 3, which is formed integrally with the housing 2, such that it approaches (sits on) and is detached from (is separated from) the valve seat 3. The coil spring 7 urges a valve head portion 5 and a valve axial portion 6 of the poppet valve 4 in a valve closing operating direction (direction in which the poppet valve 4 sits on the valve seat 3). The seal rubber 9 is attached by baking or the like, to surround the valve head portion 5 of the poppet valve 4.

The secondary air supply system of the first embodiment has an engine control unit (ECU: not shown) that electronically controls an actuator, which is a power source of the secondary air control valve 1, and the electric motor, which is a power source of the electrical air pump 14, based on operating condition of the engine 10.

The ECU has a CPU that performs control processing and arithmetic processing, a storage unit (memories such as ROM and RAM) that stores various programs and data, an input circuit (input part), an output circuit (output part), and a widely known structured microcomputer that has functions such as a electromagnetic valve drive circuit and a pump drive circuit. When an ignition switch is turned on (IG•ON), the ECU regulates driving power that is supplied to the actuator of the secondary air control valve 1 to control the opening-closing operation of the ASV of the secondary air control valve 1, and regulates electric power that is supplied to the electric motor of the electrical air pump 14 to control rotating operation (e.g., rotation speed) of the electrical air pump 14, based on a control program stored in the memory.

When the engine 10 is started, the ECU detects exhaust gas temperature by the exhaust temperature sensor. When the exhaust gas temperature is decreased to equal to or smaller than a predetermined value, the ECU supplies driving power to the actuator of the secondary air control valve 1 to drive the poppet valve 4 of the ASV to open. Meanwhile, electric power is supplied to the electric motor of the electrical air pump 14, so that the secondary air flow is generated in the secondary air flow passage pipes 11, 12. In addition, the ECU has a failure diagnostic function of diagnosing extraordinary failure of the electrical air pump 14. When secondary air pressure, which is detected by the pressure sensor 27 that is disposed in the secondary air flow passage pipes 11, 12, is outside a predetermined pressure range, the ECU determines the failure to restrict or shut off electric power supplied to the actuator of the secondary air control valve 1 and the electric motor of the electrical air pump 14.

The housing 2 of the ASV is produced from metal materials (e.g., aluminium die casting). A cylindrical wall portion 51 having a cylindrical shape is formed integrally with the housing 2, and the poppet valve 4 is received and held in the cylindrical wall portion 51 such that it can be opened or closed. An inlet pipe 52, which extends radially with respect to a direction of an axis line of the cylindrical wall portion 51 of the housing 2, is formed integrally with the cylindrical wall portion 51.

In the first embodiment, secondary air flows from an inlet portion (inlet port) 53 of the inlet pipe 52 into the inward (air passing hole 55) of the valve seat 3 of through the inside (fluid drawing passage 54) of the housing 2. A communicating passage 56, which is communicated between the air passing hole 55 of the ASV and the air passing outlets 43 of the check-valve, is formed at an outlet portion of the housing 2. A joined portion 57, which is joined to the housing 41 of the check-valve, is formed at an opening end outer portion of the outlet portion of the housing 2.

In the first embodiment, the secondary air passage 35 formed in the ASV includes the air passing hole 55 formed at the inward of the valve seat 3, and the fluid drawing passage 54 and the communicating passage 56, which are formed in the housing 2.

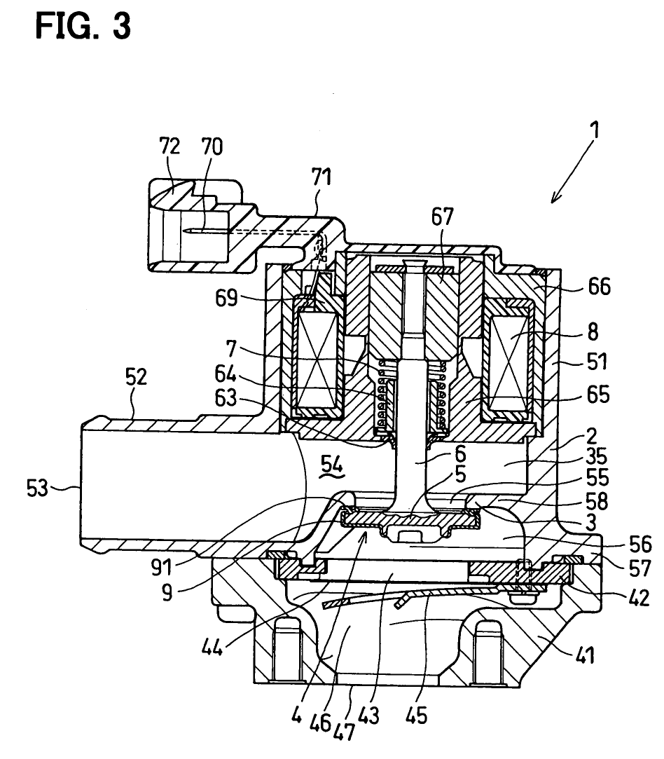

An annular division wall portion 58, which divides the inside (secondary air passage 35) of the housing 2 into two fluid passages (fluid drawing passage 54 and communicating passage 56), is formed at an inner circumferential portion of the cylindrical wall portion 51 of the housing 2. The annular valve seat 3, on which a sealing lip 91 of the seal rubber 9 attached on the valve head portion 5 of the poppet valve 4 can sit, is formed integrally with a lower end surface (FIG. 3) of the division wall portion 58 of the housing 2. The circular air passing hole (a fluid passing hole, a valve hole of the ASV, a flow passage hole) 55, through which secondary air flows, is formed at the inward of the valve seat 3.

The valve seat 3 corresponds to a opening portion around the air passing hole 55, and is formed from the same material as the housing 2 is formed. A lower end surface (annular end face) (FIG. 3) of the valve seat 3 is used as a restriction surface, which restricts an operating range of the poppet valve 4 in a direction of its axis line. Accordingly, when the sealing lip 91 of the seal rubber 9 attached on the valve head portion 5 of the poppet valve 4 sits (is closely attached) on the valve seat 3, further movement of the poppet valve 4 toward the other side (valve closing operating direction) in the direction of the axis line is restricted.

Additionally, after producing the valve seat 3, for example, from stainless steel, independently of the housing 2, the valve seat 3 may be joined to the inside of the housing 2.

The poppet valve 4 of the ASV is integrally formed from metal materials (e.g., stainless steel) or resin materials, and is movably received in the housing 2. The poppet valve 4 is a valve body (of the secondary air control valve 1), which closes or opens the air passing hole 55 by approaching and being detached from the valve seat 3 of the housing 2. The poppet valve 4 has the flange-like valve head portion (valve head) 5 and the column-shaped valve axial portion (valve shaft) 6, and makes reciprocating motion in the direction of its axis line. The valve head portion 5 is received in the inside (communicating passage 56) of the housing 2 such that it can be opened or closed. The valve axial portion 6 extends from a central portion (valve central portion) of the valve head portion 5 straight toward an actuator-side (upper side in FIG. 3).

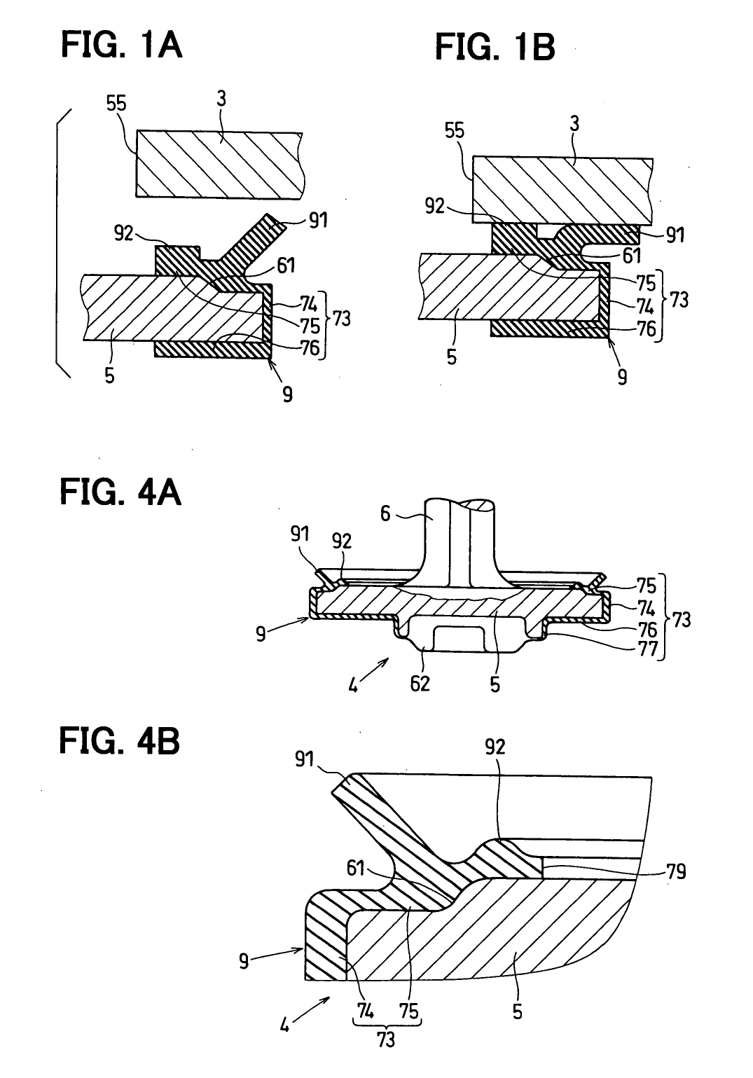

As shown in FIGS. 1A, 1B, 4A, 4B, the valve head portion 5 has a function as an opposing portion (valve body of the ASV), which is opposed to the valve seat 3 of the housing 2 with a predetermined gap therebetween. A back surface portion of the valve head portion 5 is a valve opposing surface (valve face), which sits on the lower end surface (FIG. 3) of the valve seat 3. The valve head portion 5 is formed in a flanged (disk-shaped) manner at one end portion (lower end portion in FIG. 3) of the valve axial portion 6 in its central axial direction, such that the valve head portion 5 has a larger outer diameter than the valve axial portion 6.

The valve face of the valve head portion 5 of the poppet valve 4, with the valve face opposed to the valve seat 3 of the housing 2 with the predetermined gap (sealing allowance) therebetween, has a tapered stepped portion 61. A projecting portion 62 is formed on a valve end face, which is on the other side of a valve face-side of the valve head portion 5.

The valve axial portion 6 penetrates through the air passing hole 55 in its axial direction. In addition, after producing the valve head portion 5 and the valve axial portion 6 independently, the poppet valve 4, as a result of joining the valve head portion 5 and the valve axial portion 6 such that they can be moved together, may be employed.

The poppet valve 4 is structured such that the valve head portion 5 is held (disposed) in a space (on a downstream side of the secondary air passage 35, i.e., communicating passage 56) between the check-valve and the valve seat 3 while the valve head portion 5 is separated (lifted) from the valve seat 3, that is, while the poppet valve 4 is fully opened (the poppet valve 4 is opened). In other words, the poppet valve 4 is displaced toward one side (check-valve side) in the central axial direction of the poppet valve 4 when the poppet valve 4 is fully opened.

In the first embodiment, when the poppet valve 4 is displaced toward the one side (valve opening operating direction) in its axial direction, the sealing lip 91 of the seal rubber 9 attached on the valve head portion 5 is separated from the valve seat 3 to set the ASV in a fully open position, in which the air passing hole 55 is opened (fully opened). Also, when the poppet valve 4 is displaced toward the other side (valve closing operating direction) in its axial direction, the sealing lip 91 of the seal rubber 9 attached on the valve head portion 5 sits on the valve seat 3 to set the ASV in a fully closed position, in which the air passing hole 55 is blocked (fully closed).

Thus, when the poppet valve 4 is closed (fully closed), the ASV is set in the fully closed position, and when the poppet valve 4 is opened (fully opened), the ASV is set in the fully open position. That is, in the ASV, a position of the poppet valve 4 is switched between two positions, namely the fully open position and the fully closed position.

An annular seal rubber 63 to prevent dust from entering to a sliding portion of the valve axial portion 6 is attached to an outer circumferential portion of the middle of the valve axial portion 6. Furthermore, a plate pressure 64, which functions as a stopper restricting a maximum lifted amount of the poppet valve 4, is disposed on an upper end side (FIG. 3) of the seal rubber 63.

The ASV of the first embodiment has a valve drive unit (actuator) to drive the poppet valve 4 in the valve opening operating direction. The actuator has the cylindrical wall portion 51 of the housing 2, an electromagnet including a coil 8, which generates magnetic force upon energization, and a moving core 67 that is attracted to the electromagnet.

The electromagnet has the coil 8, a stator core 65 and a yoke 66. When driving power is supplied to the coil 8, the stator core 65 and the yoke 66 are magnetized to become electromagnets. The stator core 65 has an attraction portion to attract the moving core 67.

The moving core 67 is forcibly inserted around and fixed on the outer circumferential portion of the valve axial portion 6 (particularly a small diameter portion of the valve axial portion 6) of the poppet valve 4, and when driving power is supplied to the coil 8, the moving core 67 is magnetized to be displaced together with the poppet valve 4 in a stroke direction (a lower side in FIG. 3 in the axial direction of the valve axial portion 6).

In the first embodiment, the stator core 65, the yoke 66, and the moving core 67 are provided as a plurality of magnetic materials, which form magnetic circuits together with the coil 8. However, the yoke 66 may not be used, and only the stator core 65 and the moving core 67 may be employed as the plurality of magnetic materials, which form magnetic circuits with the coil 8. Furthermore, the stator core 65 may be divided into two parts and above.

The coil spring 7 is received and held between the plate pressure 64 and the moving core 67. The coil spring 7 generates urging force (spring load) applied to the moving core 67, in a direction in which the moving core 67 is returned to a position shown in FIG. 3 (default position). The coil spring 7 serves as a load applying means for generating urging force (spring load) applied to the poppet valve 4 and the moving core 67, to urge the sealing lip 91 of the seal rubber 9 in a direction in which it is pressed on the valve seat 3.

The coil 8 is formed as a result of winding a conductive wire having a dielectric layer around an outer circumferential portion of a coil bobbin 69 made of resin a plurality of times, and is an exciting coil (solenoid coil) that generates magnetic attraction (magnetomotive force) when driving power is supplied. The coil 8 generates a magnetic flux peripherally when it is energized. Accordingly, the moving core 67, the stator core 65, and the yoke 66 are magnetized, and the moving core 67 is attracted to the attraction portion of the stator core 65 to be displaced in the stroke direction. The coil 8 and the coil bobbin 69 are held in a cylindrical space (coil receiving portion) between an inner circumferential portion of the cylindrical wall portion 51 of the housing 2 (or yoke 66) and an outer circumferential portion of a cylindrical portion of the stator core 65.

The coil 8 has a coil portion, which is wound between a pair of flanged portions of the coil bobbin 69, and a pair of terminal lead wires (terminal wires), which are taken out of the coil portion. An outer diameter side of the coil portion of the coil 8 is covered with and protected by a resin molding member, which serves as a resin case. The pair of terminal lead wires of the coil 8 is electrically connected to a pair of external connecting terminals (terminals) 70 by calking, welding, or the like. An end portion of the pair of terminals 70 is exposed in a connector shell (male connector) 72 of a connector housing 71 made of resin, and serves as a connector pin, into which a female connector on an external power source-side or on an electromagnetic valve drive circuit-side is plugged, thereby making electrical connection therebetween.

The seal rubber 9 has excellent durability and formativity, and is made of rubber elastic materials (e.g., fluoro rubber or silicon rubber) having flexibly elastically deforming properties (flexibility and considerable elastic deformation). The seal rubber 9 is a sealing member for improving sealing properties (air tight retentivity) between the valve seat 3 and the valve head portion 5 when the valve head portion 5 of the poppet valve 4 approaches the valve seat 3, and is attached on the periphery of the valve head portion 5, which is opposed to the valve seat 3 by baking or the like.

The seal rubber 9 has a cylindrical rubber sheet (covering portion) 73, which partly covers an outer circumferential portion of the valve head portion 5 of the poppet valve 4.

The rubber sheet 73 has a cylindrical portion 74, an annular portion 75, an annular portion 76, and a cylindrical portion 77. The cylindrical portion 74 covers a valve outer diameter surface (outer circumferential end face) of the valve head portion 5 of the poppet valve 4. The cylindrical portion 74 corresponds to a maximum outer diameter portion of the rubber sheet 73. The annular portion 75 covers a valve opposing surface including the stepped portion 61 of the valve head portion 5 of the poppet valve 4. The annular portion 76 covers a valve end face of the valve head portion 5 of the poppet valve 4. The cylindrical portion 77 covers a side surface of the projecting portion 62 of the valve head portion 5 of the poppet valve 4. The cylindrical portion 77 corresponds to a minimum outer diameter portion of the rubber sheet 73.

In addition, a circular opening 79 is formed inward of the annular portion 75.

The circular truncated coned and cylindrical sealing lip 91 is provided on a surface of the rubber sheet 73 of the seal rubber 9, that is, on a surface of the annular portion 75 to improve airtightness (adhesiveness) with the valve seat 3 of the housing 2. The sealing lip 91 is provided to project from the surface of the rubber sheet 73 of the seal rubber 9 into a valve seat 3-side by a predetermined projecting amount (e.g., approximately 1 [mm]).

As shown in FIG. 1A, FIGS. 4A, 4B, a cross-sectional shape of the sealing lip 91 in a natural (valve free) state before the sealing lip 91 sits on the valve seat 3 of the housing 2 is a tapered shape, which is extending generally linearly from the surface of the annular portion 75 of the rubber sheet 73 of the seal rubber 9 toward the valve seat 3-side, being inclined by an predetermined inclined angle relative to the central axial direction of the poppet valve 4.

A linear distance, parallel to a central axis of the valve head portion 5 of the poppet valve 4 or of the seal rubber 9, between a peak surface of a load receiving portion 92 and a front edge portion (corner portion) of the sealing lip 91, in the valve free state, is the sealing allowance of the sealing lip 91.

The sealing lip 91 has flexibly elastically deforming properties in all directions. Even if there is a finely unlevel area on a surface of the valve seat 3 of the housing 2, when the sealing lip 91 sits on the valve seat 3 of the housing 2, the sealing lip 91 is elastically deformed to be bent over toward an opposite side (valve outer diameter side) from the center of the poppet valve 4, being closely-attached on the surface of the valve seat 3. Accordingly, when the poppet valve 4 is fully closed, a gap between the valve seat 3 of the housing 2 and the valve head portion 5 of the poppet valve 4 is reliably sealed.

In addition to the sealing lip 91, at least one load receiving portion 92, to which a valve closing load of the poppet valve 4 is applied through the contact with the valve seat 3 of the housing 2 when the poppet valve 4 is fully closed, is formed on the surface of the rubber sheet 73 of the seal rubber 9, that is, on the surface of the annular portion 75. The load receiving portion 92 is located on a more inner diameter side (toward the central axis of the valve head portion 5) of the poppet valve 4 than the sealing lip 91 of the seal rubber 9. The load receiving portion 92 is provided to project from the surface of the rubber sheet 73 of the seal rubber 9 toward the valve seat 3-side by a predetermined projecting amount (smaller projecting amount than the projecting amount of the sealing lip 91, e.g., approximately 0.1 to 0.5 [mm]). The load receiving portion 92 is a projection with a hemisphere face (or column-shaped projection), which projects from the surface of the annular portion 75 of the rubber sheet 73 of the seal rubber 9 toward the valve seat 3-side.

When there is one load receiving portion 92, the load receiving portion 92 is disposed in a ring-shaped (annular) manner with the central axis of the valve head portion 5 of the poppet valve 4 or of the seal rubber 9 being its center. When there is a plurality of load receiving portions 92, they are located on the same circumference with the central axis of the valve head portion 5 of the poppet valve 4 or of the seal rubber 9 being its center.

The dimensions (superficial area, size) of the load receiving portion 92 are determined according to urging force (spring load) of the coil spring 7. The dimensions (superficial area, size) of the load receiving portion 92 are determined according to a compressed allowance of the load receiving portion 92 when the load receiving portion 92 is elastically deformed (compressively deformed) in a direction of height (through-thickness direction of the annular portion 75 of the rubber sheet 73 of the seal rubber 9) of the load receiving portion 92 through the contact with the valve seat 3 of the housing 2.

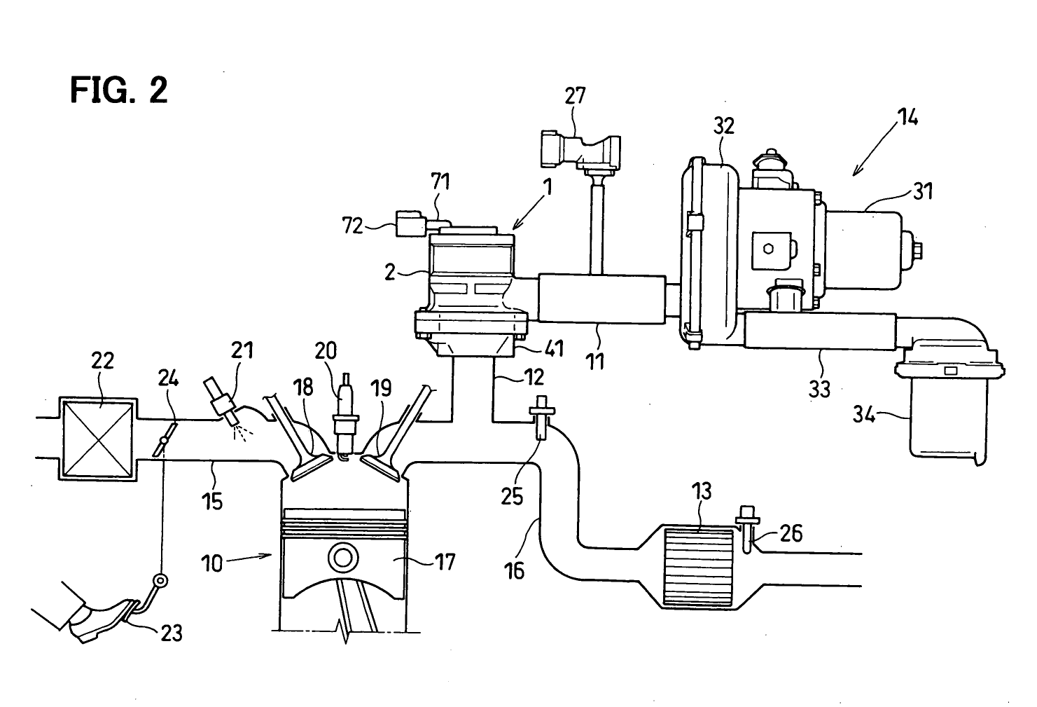

Workings of the secondary air supply system according to the first embodiment, particularly workings of the secondary air control valve 1 integrated into the secondary air supply system, that is, a flow of secondary air when the secondary air control valve 1 is driven to be opened is described with reference to FIGS. 1A to 4B.

The exhaust emission control system such as the three-way catalytic converter 13 that makes harmless three elements together, namely carbon monoxide (CO), hydrocarbon (HC), and nitrogen oxides (NOₓ), which are harmful components in exhaust gas discharged from the combustion chamber of the engine 10, through a chemical reaction, and particularly that makes hydrocarbon (HC) harmless water (H₂O) through an oxidative effect, is installed in a vehicle such as an automobile, in which the engine 10 is installed.

However, the chemical reaction is not carried out properly through the three-way catalyst unless the air/fuel ratio between air and fuel while combustion in the engine 10 is under way is a theoretical air/fuel ratio. Thus, the theoretical air/fuel ratio, which is 15 to 1, needs to be maintained. Also, the three-way catalyst does not operate properly when the exhaust gas temperature is low (equal to or smaller than approximately 350° C.), such as immediately after the engine 10 is started.

Preferably, the three-way catalyst may be activated in the following manner. When the exhaust gas temperature is low, such as immediately after the engine 10 is started, the electrical air pump 14 is operated to rotate by supplying electric power to the electric motor of the electrical air pump 14 to drive the pump impeller of the electrical air pump 14 to rotate, thereby generating secondary air in the secondary air flow passage pipes 11, 12 of the secondary air supply system. Then, secondary air generated through the rotating operation of the electrical air pump 14 is drawn into the three-way catalytic converter 13 through the secondary air flow passage pipe 11, the secondary air control valve 1, the secondary air flow passage pipe 12, and the engine exhaust pipe 16 in this order, so that warming-up of the three-way catalyst is promoted and the three-way catalyst is activated.

When the exhaust gas temperature is low, such as immediately after the engine 10 is started (when exhaust gas temperature detected by the exhaust temperature sensor is lower than a predetermined value, or when temperature of the three-way catalyst detected by the catalyst temperature sensor 26 is lower than a predetermined value), the ECU operates the electrical air pump 14 to rotate by supplying electric power (pump driving current) to the electric motor of the electrical air pump 14. As a result, secondary air starts to be supplied by pumping, through the rotating operation of the electrical air pump 14.

As well, the ECU drives the poppet valve 4 to open by supplying electric power (electromagnetic valve driving current) to the actuator of the ASV of the secondary air control valve 1, particularly to the coil 8 of the electromagnet.

When the coil 8 of the ASV is energized, magnetomotive force is generated in the coil 8, and the stator core 65, the yoke 66, and the moving core 67 are magnetized. Accordingly, the moving core 67 is attracted to the attraction portion of the stator core 65 to be displaced toward the one side in its axial direction. The valve axial portion 6 of the poppet valve 4 is displaced toward the one side in its axial direction by the displacement of the moving core 67 toward the one side in its axial direction.

Meanwhile, the sealing lip 91 of the seal rubber 9, which covers the valve face (valve opposing surface) of the valve head portion 5 of the poppet valve 4, is separated from the valve seat 3 of the housing 2, and thereby the air passing hole 55 is opened.

The valve head portion 5 of the poppet valve 4 is lifted toward a downstream side of the valve seat 3 in the secondary air flowing direction. Thus, while the poppet valve 4 is opened, a valve opening state is maintained with the valve head portion 5 being in a position (fully open position) immediately before the air passing outlets 43 of the check-valve.

Secondary air discharged from an outlet of the pump housing 32 of the electrical air pump 14 flows from the inlet port 53 of the inlet pipe 52 into the inside (secondary air passage 35, particularly fluid drawing passage 54) of the housing 2 of the ASV of the secondary air control valve 1 through the secondary air flow passage pipe 11. Secondary air, which flows into the fluid drawing passage 54, flows into the air passing hole 55 formed at the inward of the valve seat 3. Secondary air flowing through the air passing hole 55 flows into the air passing outlets 43 of the check-valve through a space in the communicating passage 56 between a peripheral portion of the valve head portion 5 of the poppet valve 4 and a passage wall surface of the communicating passage 56. The reed valve 44 of the check-valve is opened by pressure of secondary air, which flows into the air passing outlets 43, so that the air passing outlets 43 is opened.

Secondary air, which flows through the air passing outlets 43 of the check-valve, flows out of the outlet port 47 of the check-valve through the inside (fluid delivery passage 46) of the housing 41 of the check-valve. Secondary air, which flows out of the outlet port 47, is drawn into the three-way catalytic converter 13 through the secondary air flow passage pipe 12 and the engine exhaust pipe 16 in this order. Since secondary air generated through the rotating operation of the electrical air pump 14 is drawn into the three-way catalytic converter 13 even when the exhaust gas temperature is low such as immediately after the engine 10 is started, oxygen (O₂) is combusted and the three-way catalyst is sublimed and activated. Particularly by making hydrocarbon (HC) harmless water (H₂O) through the oxidative effect, an amount of emission of hydrocarbon into the atmosphere is reduced.

On the other hand, when exhaust gas temperature detected by the exhaust temperature sensor is increased to equal to or larger than the predetermined value, or when temperature of the three-way catalyst detected by the catalyst temperature sensor 26 is increased to equal to or larger than the predetermined value, the ECU stops supplying electric power to the actuator (coil 8) of the ASV of the secondary air control valve 1 and to the electric motor of the electrical air pump 14. Accordingly, the supply of secondary air by pumping through the rotating operation of the electrical air pump 14 is ended, and the poppet valve 4 of the ASV of the secondary air control valve 1 is returned to the fully closed position by urging force of the coil spring 7.

As a result, the sealing lip 91 of the seal rubber 9 attached on the valve head portion 5 of the poppet valve 4 is closely-attached on (sits on) the valve seat 3 of the housing 2, thereby closing the air passing hole 55.

As described above, in the secondary air control valve 1, which is integrated into the secondary air supply system of the first embodiment, the seal rubber 9 made of rubber elastic materials is attached on the periphery of the valve head portion 5 of the poppet valve 4 of the ASV by baking or the like. The sealing lip 91 with which to seal the gap between the valve seat 3 of the housing 2 and the valve face of the valve head portion 5 of the poppet valve 4 when the poppet valve 4 is fully closed (sits on the valve seat 3) is formed integrally with the seal rubber 9.

An excessive stress is repeatedly applied to a base portion (root portion) of the sealing lip 91 of the seal rubber 9 every time the sealing lip 91 of the seal rubber 9 sits on (is closely-attached on) the valve seat 3 of the housing 2. Accordingly, defects such as a crack are caused at the root portion of the sealing lip 91, so that there is a possibility of shortening a lifetime (endurance) of the seal rubber 9, or of decreasing sealing properties (hermeticity) between the valve seat 3 of the housing 2 and the valve face of the valve head portion 5 of the poppet valve 4.

Consequently, in the seal rubber 9 having the sealing lip structure in the first embodiment, the load receiving portion 92, to which the valve closing load due to urging force (spring load) of the coil spring 7 and the like while the poppet valve 4 is fully closed is applied, is provided independently of the sealing lip 91, that is, independently in a different position from the sealing lip 91. In other words, instead of allocating all the valve closing load due to the spring load and the like while the poppet valve 4 is fully closed only to the sealing lip 91, part of the valve closing load is allocated to the load receiving portion 92, and the rest of the valve closing load is allocated to the sealing lip 91. As a result, the valve closing load applied to the sealing lip 91 while the poppet valve 4 is fully closed can be effectively reduced, thereby effectively reducing the excessive stress applied to the sealing lip 91, particularly to the root portion of the sealing lip 91 while the poppet valve 4 is fully closed (having a profound stress reducing effect).

Accordingly, defects such as a crack at the root portion of the sealing lip 91 due to the excessive stress repeatedly applied to the root portion of the sealing lip 91 every time the sealing lip 91 of the seal rubber 9 sits on (is closely-attached on) the valve seat 3 of the housing 2 can be restricted.

Therefore, shortening of a lifetime of the sealing lip 91 of the seal rubber 9 can be restricted, thereby improving the endurance of the seal rubber 9.

Furthermore, decrease in a sealing function while the poppet valve 4 is fully closed is restricted, so that a leak of fluid such as high-temperature exhaust gas from the gap between the valve seat 3 of the housing 2 and the valve face of the valve head portion 5 of the poppet valve 4 into the electrical air pump 14-side while the poppet valve 4 is fully closed can be restricted. Accordingly, a flow of high-temperature exhaust gas into the inside (fluid drawing passage 54) of the housing 2 of the ASV of the secondary air control valve 1 can be restricted. As a result, the flow of high-temperature exhaust gas into the inside of the system on the electrical air pump 14-side of the valve seat 3 of the housing 2 is reliably restricted, so that abnormal temperature rising in the secondary air supply system can be restricted. Hence, a system failure is restricted.

In the ASV of the secondary air control valve 1 of the first embodiment, the load receiving portion 92, to which the valve closing load is applied through the contact with the valve seat 3 when the poppet valve 4 is fully closed, is provided to one seal rubber 9 (one component) made of rubber elastic materials in addition to the sealing lip 91. Thus, the sealing lip 91 and the load receiving portion 92 can be set with high dimensional accuracy, thereby improving the stress reducing effect on the root portion of the sealing lip 91 as well as an effect of preventing the leakage of fluid such as high-temperature exhaust gas while the poppet valve 4 is fully closed.

Because the seal rubber 9 is made of rubber elastic materials, when the sealing lip 91 of the seal rubber 9 sits on (is closely-attached on) the valve seat 3 of the housing 2, the sealing lip 91 is closely-attached on the valve seat 3 of the housing 2, being elastically deformed. Accordingly, the gap between the valve seat 3 of the housing 2 and the valve face of the valve head portion 5 of the poppet valve 4 is reliably airtightly sealed. Besides, by using the load receiving portion 92 of the seal rubber 9 as a rubber cushion, an impact when the valve face of the valve head portion 5 of the poppet valve 4 sits on the valve seat 3 of the housing 2 is absorbed. As well, a sitting sound (operating sound) of the valve head portion 5 of the poppet valve 4 on the valve seat 3 can be reduced.

### Second Embodiment

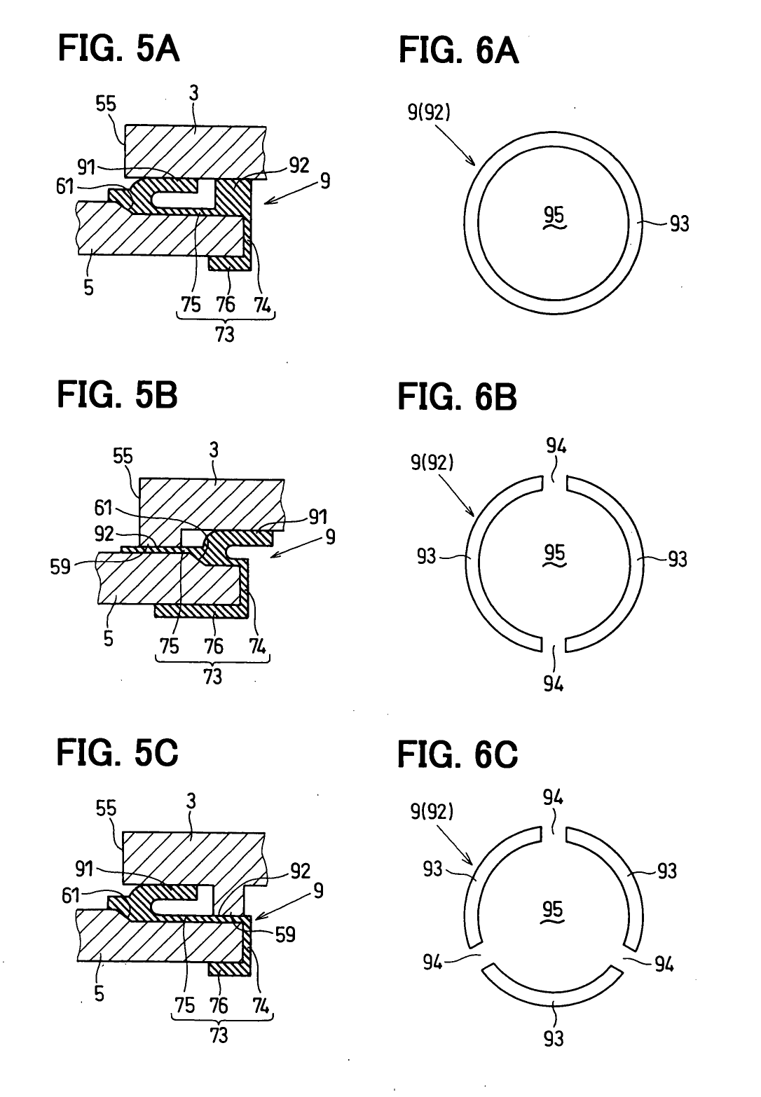

FIGS. 5A to 5C show states of elastic deformation of a sealing lip 91 while a poppet valve 4 is fully closed according to a second embodiment of the present invention.

As shown in FIGS. 5A to 5C, a seal rubber 9 having a rubber sheet 73, which partly covers a valve head portion 5, is attached on the periphery of the valve head portion 5 of the poppet valve 4 of the second embodiment by baking or the like.

On a surface of the rubber sheet 73 of the seal rubber 9, that is, on a surface of an annular portion 75, a load receiving portion 92, to which a valve closing load of the poppet valve 4 is applied, is integrally formed, in addition to the sealing lip 91. As shown in FIG. 5A, the load receiving portion 92 of the seal rubber 9 is provided on a valve outer diameter-side of the sealing lip 91 of the seal rubber 9 (on the opposite side of a central axis of the valve head portion 5 of the poppet valve 4).

As shown in FIGS. 5A to 5C, when the sealing lip 91 of the seal rubber 9 sits on the valve seat 3 of the housing 2, the sealing lip 91 is elastically deformed to be bent over toward the opposite side of the central axis of the valve head portion 5 of the poppet valve 4 (toward the valve outer diameter-side). Alternatively, when the sealing lip 91 of the seal rubber 9 sits on the valve seat 3 of the housing 2, the sealing lip 91 may be elastically deformed to be bent over toward the central axis of the valve head portion 5 of the poppet valve 4 (toward a valve inner diameter-side).

As shown in FIGS. 5B, 5C, an annular (or partly annular) projecting portion 59, which projects into a load receiving portion 92-side, is formed integrally with the valve seat 3 of the housing 2 of the second embodiment.

In the seal rubber 9 of the second embodiment, as shown in FIG. 5B, the surface of the annular portion 75 of the rubber sheet 73 and a surface (peak surface) of the load receiving portion 92 are disposed in the same plane. The load receiving portion 92 of the seal rubber 9 is provided on the valve inner diameter-side of the sealing lip 91 of the seal rubber 9 (toward the central axis of the valve head portion 5 of the poppet valve 4).

In the seal rubber 9 of the second embodiment, as shown in FIG. 5C, the surface of the annular portion 75 of the rubber sheet 73 and the surface (peak surface) of the load receiving portion 92 are disposed in the same plane. The load receiving portion 92 of the seal rubber 9 is provided on the valve outer diameter-side of the sealing lip 91 of the seal rubber 9 (on the opposite side of the central axis of the valve head portion 5 of the poppet valve 4).

Similar to the first embodiment, in the seal rubber 9 having the sealing lip structure of the second embodiment as well, an excessive stress applied to the sealing lip 91, particularly to a root portion of the sealing lip 91 while the poppet valve 4 is fully closed is effectively reduced. Thus, defects such as a crack at the root portion of the sealing lip 91 can be restricted. Accordingly, endurance of the seal rubber 9 is improved, and decrease in a sealing function while the poppet valve 4 is fully closed is restricted.

### Third Embodiment

FIGS. 6A to 6C show a load receiving portion 92 of a seal rubber 9 according to a third embodiment of the present invention.

As shown in FIGS. 6A to 6C, on a surface of a rubber sheet 73 of the seal rubber 9 of the third embodiment, that is, on a surface of an annular portion 75, the load receiving portion 92, to which a valve closing load of a poppet valve 4 is applied, is integrally formed, in addition to a sealing lip 91.

As shown in FIG. 6A, the seal rubber 9 of the third embodiment includes an annular (ring-shaped) projecting portion 93 as a result of the load receiving portion 92 projecting from the surface of the rubber sheet 73 of the seal rubber 9 into a valve seat 3-side. The projecting portion 93 is disposed on the same circumference with a central axis of a valve head portion (disk-shaped portion) 5 of the poppet valve 4 or of the seal rubber 9 being its center.

In addition, as shown in FIGS. 5B, 5C in the second embodiment, the surface of the annular portion 75 of the rubber sheet 73 and a surface (peak surface) of the load receiving portion 92 may be disposed in the same plane, and an annular (ring-shaped) projecting portion 59 may be provided to a valve seat 3 of a housing 2.

As shown in FIGS. 6B, 6C, the seal rubber 9 of the third embodiment includes a half circular arc-shaped (partly annular) projecting portion 93, as a result of the load receiving portion 92 projecting from the surface of the rubber sheet 73 of the seal rubber 9 into the valve seat 3-side. There are two or three projecting portions 93 located at predetermined intervals on the same circumference with the central axis of the valve head portion (disk-shaped portion) 5 of the poppet valve 4 or of the seal rubber 9 being its center.

In the case of the load receiving portion 92 including two or three projecting portions 93, driving force of the poppet valve 4 in opening the poppet valve 4 is smaller than the load receiving portion 92 including the ring-shaped projecting portion 93 in FIG. 6A. This is because in the case of the load receiving portion 92 including the ring-shaped projecting portion 93 in FIG. 6A, the seal rubber 9 is difficult to be separated from the valve seat 3 of the housing 2 due to a suction effect while the poppet valve 4 is fully closed. In the case of the load receiving portion 92 including two or three projecting portions 93, air enters through a gap 94 formed between two adjacent projecting portions 93 into an internal space (circular space formed between the valve seat 3 of the housing 2 and the annular portion 75 of the rubber sheet 73) 95 of the load receiving portion 92, so that the suction effect is reduced.

In the seal rubber 9 of the third embodiment as well, the dimensions (superficial area, size) of the load receiving portion 92 may be determined according to urging force (spring load) of a coil spring 7. Besides, the dimensions (superficial area, size) of the load receiving portion 92 may be determined according to a compressed allowance of the load receiving portion 92.

In addition, as shown in FIGS. 5B, 5C in the second embodiment, the surface of the annular portion 75 of the rubber sheet 73 and the surface (peak surface) of the load receiving portion 92 may be disposed in the same plane, and two or three half circular arc-shaped (partly annular) projecting portions 59 may be provided to the valve seat 3 of the housing 2.

Similar to the first embodiment, in the seal rubber 9 having the sealing lip structure of the third embodiment as well, an excessive stress applied to the sealing lip 91, particularly to a root portion of the sealing lip 91 while the poppet valve 4 is fully closed is effectively reduced. Thus, defects such as a crack at the root portion of the sealing lip 91 can be restricted. Accordingly, endurance of the seal rubber 9 is improved, and decrease in a sealing function while the poppet valve 4 is fully closed is restricted.

### Fourth Embodiment

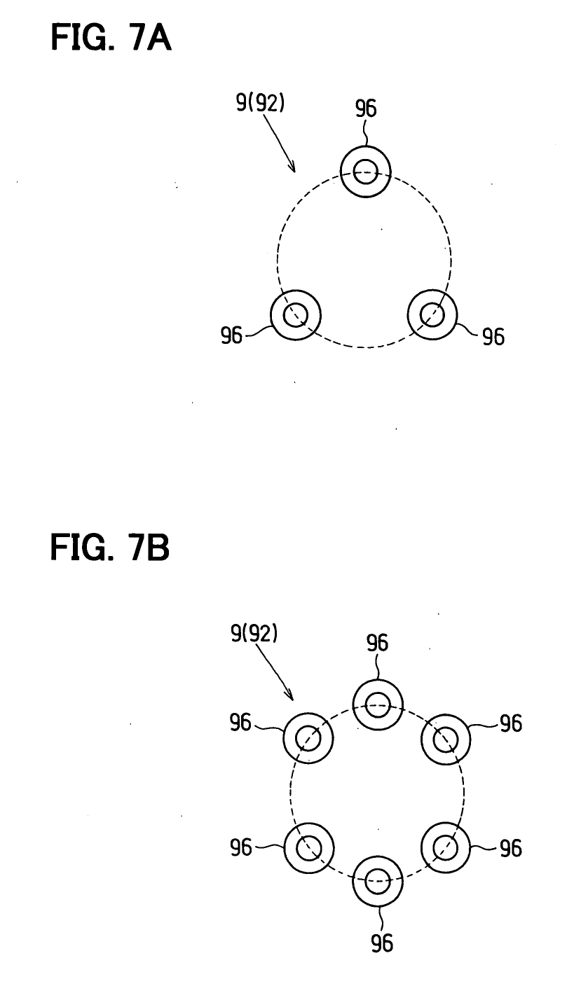

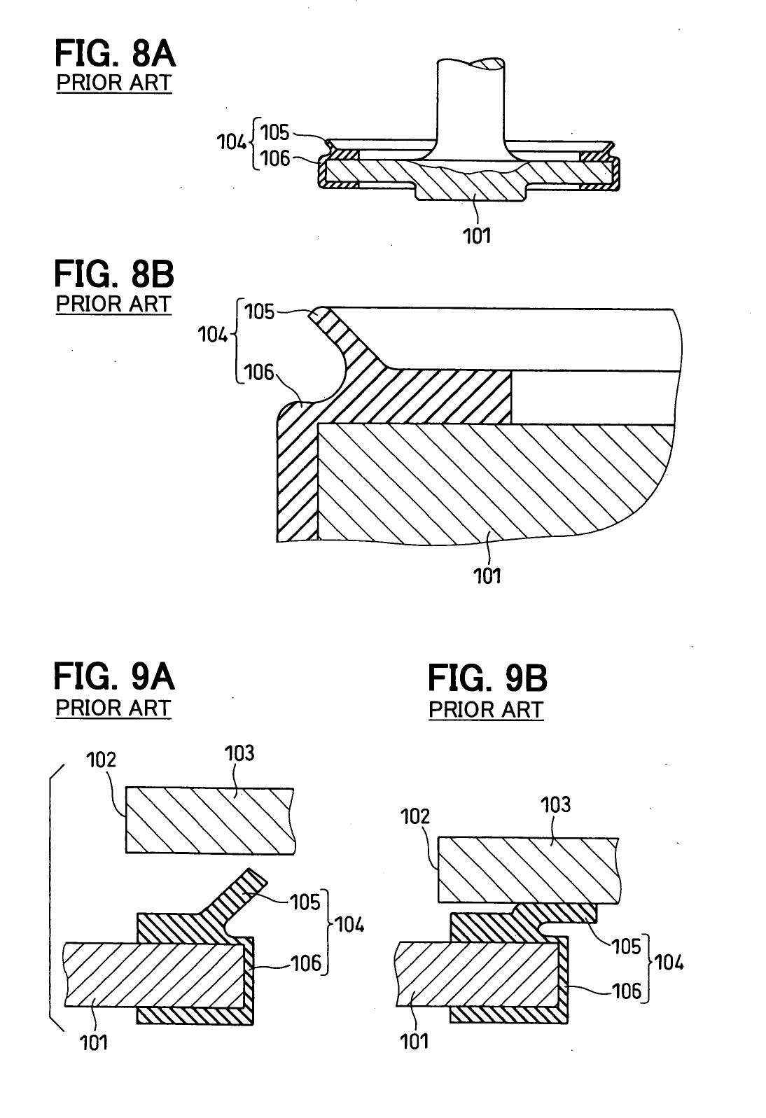

FIGS. 7A, 7B show a load receiving portion 92 of a seal rubber 9 according to a fourth embodiment of the present invention.

As shown in FIGS. 7A, 7B, on a surface of a rubber sheet 73 of the seal rubber 9 of the fourth embodiment, that is, on a surface of an annular portion 75, the load receiving portion 92, to which a valve closing load of a poppet valve 4 is applied, is integrally formed in addition to a sealing lip 91.

The seal rubber 9 of the fourth embodiment includes a circular truncated cone-shaped projecting portion (or having a hemisphere face) 96 as a result of the load receiving portion 92 projecting from the surface of the rubber sheet 73 of the seal rubber 9 into a valve seat 3-side. There are three or six projecting portions 96 located at predetermined intervals on the same circumference with a central axis of a valve head portion (disk-shaped portion) 5 of the poppet valve 4 or of the seal rubber 9 being its center.

In the seal rubber 9 of the fourth embodiment as well, the dimensions (superficial area, size) of the load receiving portion 92 may be determined according to urging force (spring load) of a coil spring 7. Besides, the dimensions (superficial area, size) of the load receiving portion 92 may be determined according to a compressed allowance of the load receiving portion 92.

In addition, as shown in FIGS. 5B, 5C in the second embodiment, the surface of the annular portion 75 of the rubber sheet 73 and a surface (peak surface) of the load receiving portion 92 may be disposed in the same plane, and two or three circular truncated cone-shaped projecting portions (or having hemisphere faces) 59 may be provided to a valve seat 3 of a housing 2.

Similar to the first embodiment, in the seal rubber 9 having the sealing lip structure of the fourth embodiment as well, an excessive stress applied to the sealing lip 91, particularly to a root portion of the sealing lip 91 while the poppet valve 4 is fully closed is effectively reduced. Thus, defects such as a crack at the root portion of the sealing lip 91 can be restricted. Accordingly, endurance of the seal rubber 9 is improved, and decrease in a sealing function while the poppet valve 4 is fully closed is restricted.

### Modifications

In the above embodiments, the secondary air control valve 1 is disposed between the secondary air flow passage pipes 11, 12 that connect the electrical air pump 14 and the engine exhaust pipe 16. However, the secondary air control valve 1 may be disposed along the secondary air flow passage pipe. For example, the secondary air control valve 1 may be disposed at a connected portion between the electrical air pump 14 and the secondary air flow passage pipe 11. Also, the secondary air control valve 1 may be disposed at a connected portion between the secondary air flow passage pipe 12 and the engine exhaust pipe 16 or an exhaust manifold. Furthermore, the poppet valve 4 having one valve head portion 5 is employed as a valve. However, equal to or more than two poppet valves having valve head portions may be employed as valves. In this case, equal to or more than two valve seats may be needed.

In the embodiments, the electromagnetic actuator (electromagnetically-driven portion) having the electromagnet including the coil 8 is employed for the valve drive unit that drives the poppet valve 4 of the ASV (electromagnetic passage opening-closing valve) of the secondary air control valve 1 to open (or close). However, a negative pressure-activated actuator, which is driven by negative pressure from a vacuum pump through a negative pressure controlled valve, may be employed for the valve drive unit that drives the valve of the fluid-controlled valve to open or close. As well, an electric actuator having an electric motor and a power transmission device (e.g., reduction gear mechanism, or movement direction conversion mechanism) may be employed for the valve drive unit.

Furthermore, the ASV may be configured such that when supply electric power (amount of supply current) such as a voltage or current value to the coil 8 increases, a lifted amount of the valve becomes large or small.

Also, gas such as evaporated fuel, and liquid such as water, fuel and oil, as well as air (secondary air), may be employed as fluid controlled by the valve of the fluid-controlled valve.

Additionally, the present invention may be applied to a valve without the actuator that drives the valve, for example, to a pressure response valve, in which a valve is opened or closed by a before-and-after pressure difference.

In the embodiments, the fluid-controlled valve of the present invention is applied to the secondary air control valve 1, which is integrated into the secondary air supply system installed in a vehicle such as an automobile. However, application is not limited to this. For example, it may be applied to an intake air flow control valve (e.g., swirl flow control valve and tumble flow control valve), an intake air amount control valve (e.g., throttle valve and idle-rotation speed control valve), an exhaust gas recirculation amount control valve (EGR control valve) integrated into an exhaust gas recirculation system (EGR system), or a pneumatic control valve (e.g., variable air-intake valve) integrated into a variable air-intake apparatus for an internal combustion engine. In such cases, check-valves do not need to be employed.

Besides, the fluid-controlled valve of the present invention may be applied to fluid-controlled valves such as a fluid passage opening-closing valve, a fluid passage shut-off valve, a fluid flow control valve, and a fluid pressure control valve. As the valve, which can sit on the valve seat of the housing, a shutter-shaped valve, a double poppet valve, a flap valve, and the like, may be employed.

Also, a single housing (tubular body) as a result of integrating the housing 41 of the check-valve with the housing 2 of the ASV may be employed.

In the embodiments, the load receiving portion 92 of the seal rubber 9 serves as a load receiving portion, to which the valve closing load (due to the spring load and the like while the poppet valve 4 is fully closed) is applied. The valve head portion 5 of the poppet valve 4 is pressed against the valve seat 3 of the housing 2 with this valve closing load while the poppet valve 4 is fully closed. However, the load receiving portion of the sealing member may serve as a load receiving portion, to which the valve closing load due to driving force of an actuator in closing the poppet valve 4 is applied. That is, a normally-closed valve or a normally-open valve may be used as a valve body of the fluid-controlled valve.

Additional advantages and modifications will readily occur to those skilled in the art. The invention in its broader terms is therefore not limited to the specific details, representative apparatus, and illustrative examples shown and described.

What is claimed is:

1. A fluid-controlled valve comprising:
a housing having an annular valve seat, which has a fluid passing hole therein;
a valve that sits on or is separated from the valve seat to close or open the fluid passing hole respectively; and
a sealing member that is attached on the valve, wherein:
the sealing member has a sealing lip, which is closely attached to the valve seat while the fluid passing hole is closed by the valve, to seal a gap between the valve seat and the valve; and
the sealing member has a load receiving portion, which contacts the valve seat while the fluid passing hole is closed by the valve, in addition to the sealing lip.

2. The fluid-controlled valve according to claim 1, wherein:
the valve has a valve opposing surface, which is opposed to the valve seat; and
the sealing member has a covering portion, which covers at least the valve opposing surface.

3. The fluid-controlled valve according to claim 2, wherein the load receiving portion includes a projecting portion, which projects from a surface of the covering portion toward the valve seat.

4. The fluid-controlled valve according to claim 2, wherein a surface of the covering portion and a surface of the load receiving portion are in the same plane.

5. The fluid-controlled valve according to claim 4, wherein the valve seat has a projecting portion, which projects toward the load receiving portion.

6. The fluid-controlled valve according to claim 1, wherein the sealing lip and the load receiving portion have one of the following positional relationships with respect to a central axis of the valve:
the load receiving portion is located between the sealing lip and the central axis of the valve; and
the sealing lip is located between the central axis of the valve and the load receiving portion.

7. The fluid-controlled valve according to claim 1, wherein the load receiving portion is located in a predetermined circle such that one of a central axis of the valve and a central axis of the sealing member passes through a center of the predetermined circle.

8. The fluid-controlled valve according to claim 1, further comprising a load applying means for generating a load to urge the valve in a direction in which the sealing member is pressed against the valve seat, wherein the load receiving portion has a predetermined size according to the load generated by the load applying means.

9. The fluid-controlled valve according to claim 1, wherein the sealing member is made of a rubber elastic material.

10. The fluid-controlled valve according to claim 9, wherein the load receiving portion has a predetermined size according to a crush allowance of the load receiving portion, which is allowed for elastic deformation of the load receiving portion in contact with the valve seat.
